(19) United States
(12) Patent Application Publication
(10) Pub. No.: US 2015/0024899 A1
(43) Pub. Date: Jan. 22, 2015

(54) VARIABLE-RADIUS CONTACT GEOMETRY FOR TRACTION DRIVES

(71) Applicant: DANA LIMITED, Maumee, OH (US)

(72) Inventor: Andrew W. Phillips, Rochester, MI (US)

(21) Appl. No.: 14/334,538

(22) Filed: Jul. 17, 2014

Related U.S. Application Data
(60) Provisional application No. 61/847,997, filed on Jul. 18, 2013.

(51) Int. Cl. F16H 15/50

(52) U.S. Cl. CPC F16H 15/503
USPC 476/37

(57) ABSTRACT

A ball-type variator having a variable contact patch geometry wherein the variator efficiency is improved when the effect of spin is reduced under light load. Said ball-type variator having said variable contact patch geometry wherein the maximum stresses are reduced at high loads.

### CROSS-REFERENCE TO RELATED APPLICATIONS

This application claims the benefit of U.S. Provisional Application No. 61/847,997 filed Jul. 18, 2013, which application is incorporated herein by reference.

### BACKGROUND OF THE INVENTION

A vehicle having a driveline including a continuously variable transmission allows an operator of the vehicle or a control system of the vehicle to vary a drive ratio in a stepless manner, permitting a power source of the vehicle to operate at its most efficient rotational speed. Transmissions are becoming more complicated since the engine speed must be more precisely controlled to limit the fuel consumption and emissions of cars. Additionally transmission component speed and efficiency is equally important.

### SUMMARY OF THE INVENTION

Recently, continuously variable transmissions, (CVT, which is also known as CVP for continuously variable planetary transmission, herein) have been proposed to provide vehicles with continuously variable speed transmissions having designs that have improved efficiency and torque capacity due to better contact patch geometry between the variator ball and the rings or idlers. An example of a CVP and further description of a CVP can be found in U.S. Ser. No. 61/819414 which is incorporated herein by reference in its entirety.

The current technology of ball-type variators for CVP and associated analyses thereof comprehends a single radius of curvature for the ball interface on the rings and/or idlers. This sets the shape of the contact patch (area) between the ball interface and the rings and/or idlers regardless of torque level, thus resulting in a single compromise between efficiency (long and skinny) and torque capacity (round to short and wide).

Provided herein is a continuously variable planetary transmission comprising a ball type variator, said ball type variator comprising a ring or idler, said ring or an idler comprising a contact patch configured to engage a ball of the ball type variator, wherein said contact patch has a variable profile such that the contact patch is configured to change shape or size during use. In some embodiments, the variable profile of said contact patch is perpendicular to a rolling direction of motion of the ball, and has decreasing convexity at increasing distance from the center of the contact patch. In some embodiments, the variable profile changes shape and size when a clamp load changes from a first clamp load to a second clamp load, wherein at least one of the shape and size of a second loading profile is wider than a first loading profile when the first clamp load associated with the first loading profile increases to the second clamp load associated with the second loading profile. Provided herein is a ball type variator comprising a ring or idler, said ring or an idler comprising a contact patch configured to engage a ball of the ball type variator, wherein said contact patch has a variable profile such that the contact patch is configured to change shape or size during use. In some embodiments, said variable profile of said contact patch of is perpendicular to a rolling direction of motion of the ball, and has decreasing convexity at increasing distance from the center of the contact patch. In some embodiments, said variable profile of said contact patch changes shape and size when a clamp load changes from a first clamp load to a second clamp load, wherein at least one of the shape and size of a second loading profile is wider than a first loading profile when the first clamp load associated with the first loading profile increases to the second clamp load associated with the second loading profile. In some embodiments, efficiency of said variator is improved when said variable profile is skinny under light load and the effect of spin is reduced. In some embodiments, maximum stresses of said variator are reduced when said variable profile is wide under heavy load.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a conceptual illustration showing the change in both shape and size of the contact patch as clamp load increases.

FIG. 2 is a conceptual illustration of a ring or idler profile perpendicular to the direction of travel which could provide an effect like that shown in FIG. 1.

FIG. 3 is a cutaway view of a currently known and used continuously variable transmission (CVT); and

FIG. 4 is a magnified cutaway view of a ball and ring of the CVT of FIG. 4.

### DETAILED DESCRIPTION OF THE INVENTION

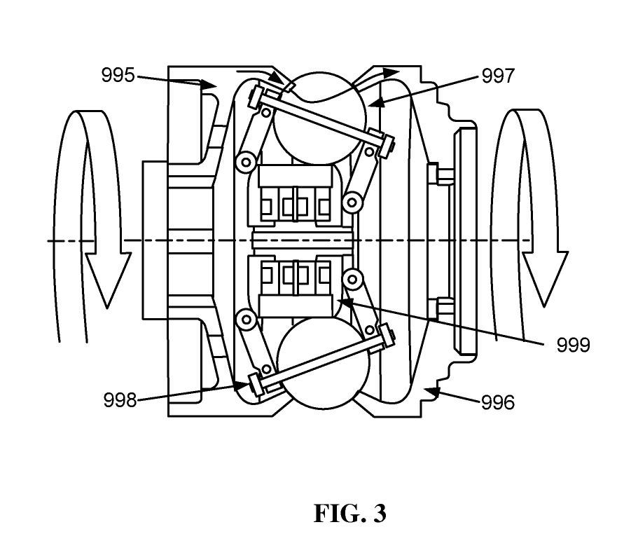

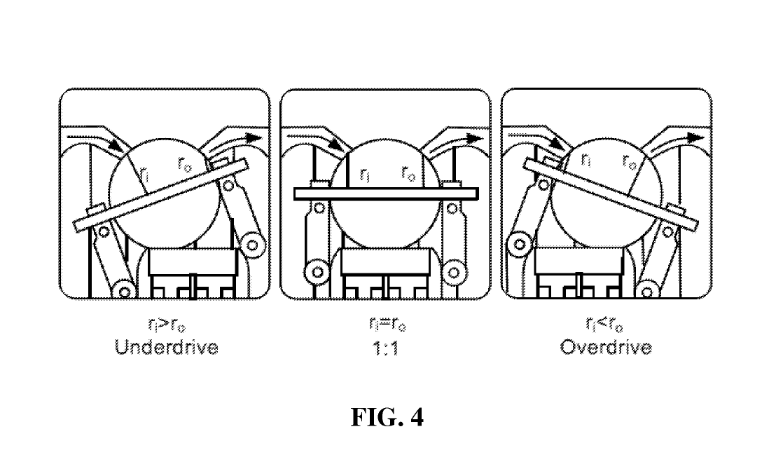

The current technology of ball-type variators for continuously variable planetary transmissions and associated analyses thereof comprehends a single radius of curvature for the ball interface on the rings and/or idlers as shown in representative FIGS. 3 and 4. This sets the shape of the contact patch (area) between the ball interface and the rings and/or idlers regardless of torque level, thus resulting in a single compromise between efficiency (long and skinny) and torque capacity (round to short and wide).

A variator ring or idler of a continuously variable planetary transmission having a variable contact patch geometry has been developed wherein, the ring(s) and/or sun(s) of a ball-type variator are profiled at the contact patch.

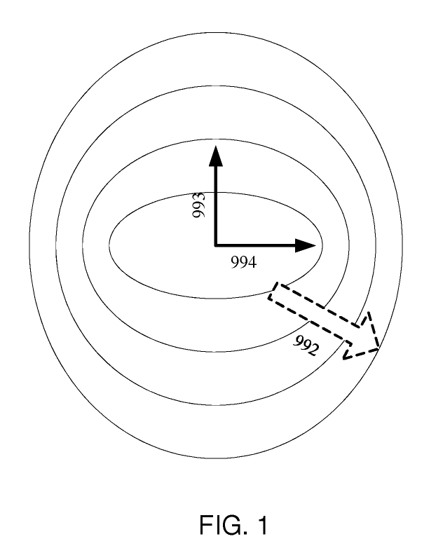

As illustrated in FIG. 1, the both shape and size of the contact patch increase as clamp load 992 increases. Under light load, the long, skinny contact patch in the middle reduces the parasitic effect of spin, which increases with the absolute value of the y axis, (ABS(y)) 993. Under heavy load, the wide contact patch on the outside spreads the load over a much larger area, reducing maximum compressive and (ideally) shear stresses. The variable profile of the contact patch is perpendicular to the rolling direction 994 of motion and has decreasing convexity at increasing distance from the center of the contact patch. As a result of this profiling technique, contact patch is wider when the load increases.

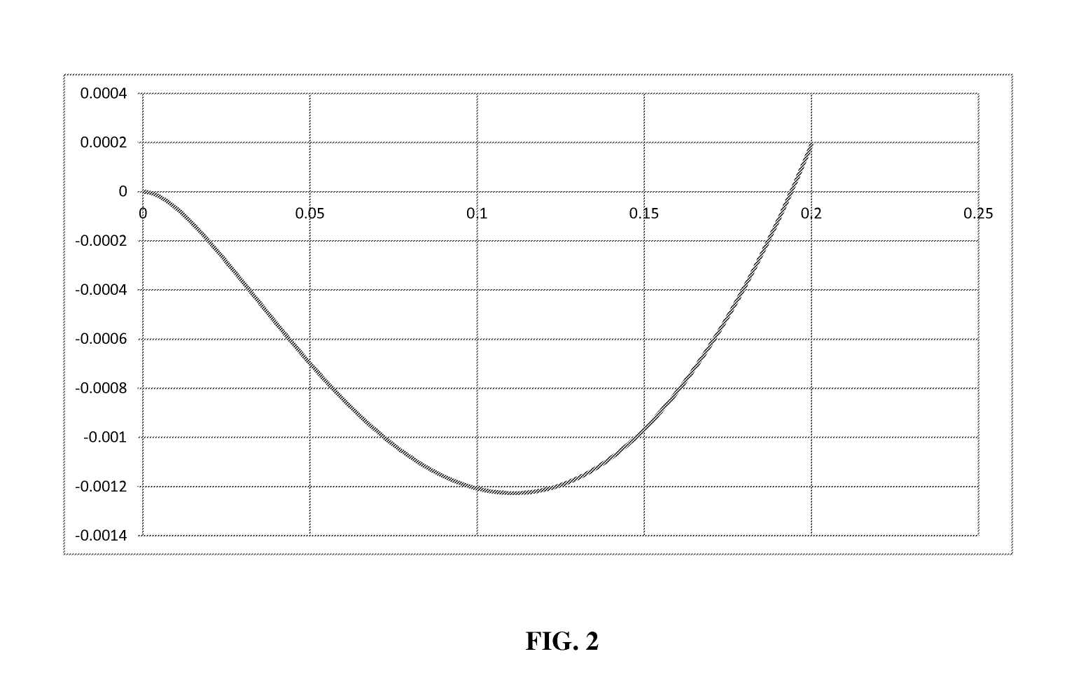

FIG. 2, is a representative example of a ring or idler profile perpendicular to the direction of travel which could provide an effect like that shown in FIG. 1. The y-axis, (highly exaggerated here), shows the “height” of the profile with upwards being towards the mating ball surface. The units are multiples of ball radii. At the initial contact point [0,0], the relative curvature is 2 (half the radius of the ball), decreasing to zero at approximately x=0.033, and further decreasing (i.e. becoming concave) asymptotically to −0.5 (i.e. twice the ball radius). As the mating surfaces are pressed harder together, the increasing concavity of the ring/idler provides a rapidly larger bearing surface, reducing the growth rate of maximum stresses.

Basic concepts of a ball type Continuously Variable Transmissions are described in US20040616399 and AU2011224083A1, incorporated herein by reference in their entirety. Such a CVT, adapted herein as described throughout this specification, comprises a number of balls 997, depending on the application, two discs with a conical surface contact with the balls, as input 995 and output 996, and an idler 999 as shown on FIG. 3. The balls are mounted on axes 998, themselves held in a cage or carrier allowing changing the ratio by tilting the balls' axes. Other types of ball CVTs also exist, like the one produced by Milner, but are slightly different.

The working principle of such a CVT of FIG. 3 is shown on FIG. 4. The CVT itself works with a traction fluid. The lubricant between the ball and the conical rings acts as a solid at high pressure, transferring the power from the input ring, through the balls, to the output ring. By tilting the balls' axes, the ratio can be changed between input and output. When the axis is horizontal the ratio is one, when the axis is tilted the distance between the axis and the contact point change, modifying the overall ratio. All the balls' axes are tilted at the same time with a mechanism included in the cage.

Provided herein is a continuously variable planetary transmission comprising a ball type variator, said ball type variator comprising a ring or idler, said ring or an idler comprising a contact patch configured to engage a ball of the ball type variator, wherein said contact patch has a variable profile such that the contact patch is configured to change shape or size during use. In some embodiments, the variable profile of said contact patch is perpendicular to a rolling direction of motion of the ball, and has decreasing convexity at increasing distance from the center of the contact patch. In some embodiments, the variable profile changes shape and size when a clamp load changes from a first clamp load to a second clamp load, wherein at least one of the shape and size of a second loading profile is wider than a first loading profile when the first clamp load associated with the first loading profile increases to the second clamp load associated with the second loading profile. Provided herein is a ball type variator comprising a ring or idler, said ring or an idler comprising a contact patch configured to engage a ball of the ball type variator, wherein said contact patch has a variable profile such that the contact patch is configured to change shape or size during use. In some embodiments, said varaible profile of said contact patch of is perpendicular to a rolling direction of motion of the ball, and has decreasing convexity at increasing distance from the center of the contact patch. In some embodiments, said variable profile of said contact patch changes shape and size when a clamp load changes from a first clamp load to a second clamp load, wherein at least one of the shape and size of a second loading profile is wider than a first loading profile when the first clamp load associated with the first loading profile increases to the second clamp load associated with the second loading profile. In some embodiments, efficiency of said variator is improved when said variable profile is skinny under light load and the effect of spin is reduced. In some embodiments, maximum stresses of said variator are reduced when said variable profile is wide under heavy load.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A continuously variable planetary transmission comprising a ball type variator, said ball type variator comprising a ring or idler, said ring or an idler comprising a contact patch configured to engage a ball of the ball type variator, wherein said contact patch has a variable profile such that the contact patch is configured to change shape or size during use.

2. The continuously variable planetary transmission of claim 1, wherein said variable profile of said contact patch is perpendicular to a rolling direction of motion of the ball, and has decreasing convexity at increasing distance from the center of the contact patch.

3. The continuously variable planetary transmission of claim 2, wherein said variable profile changes shape and size when a clamp load changes from a first clamp load to a second clamp load, wherein at least one of the shape and size of a second loading profile is wider than a first loading profile when the first clamp load associated with the first loading profile increases to the second clamp load associated with the second loading profile.

4. A ball type variator comprising a ring or idler, said ring or an idler comprising a contact patch configured to engage a ball of the ball type variator, wherein said contact patch has a variable profile such that the contact patch is configured to change shape or size during use.

5. The ball type variator of claim 4, wherein said variable profile of said contact patch is perpendicular to a rolling direction of motion of the ball, and has decreasing convexity at increasing distance from the center of the contact patch.

6. The ball type variator of claim 5, wherein said variable profile changes shape and size when a clamp load changes from a first clamp load to a second clamp load, wherein at least one of the shape and size of a second loading profile is wider than a first loading profile when the first clamp load associated with the first loading profile increases to the second clamp load associated with the second loading profile.

7. The ball type variator of claim 4, wherein efficiency of said variator is improved when said variable profile is skinny under light load and the effect of spin is reduced.

8. The ball type variator of claim 4, wherein maximum stresses of said variator are reduced when said variable profile is wide under heavy load.
